(19) United States
(12) Patent Application Publication
(10) Pub. No.: US 2018/0056845 A1
(43) Pub. Date: Mar. 1, 2018

(54) RAMP DOOR WITH SELF-DEPLOYING RAIL

(71) Applicant: LIPPERT COMPONENTS, INC., Elkhart, IN (US)

(72) Inventor: Barry OUSLEY, Syracuse, IN (US)

(21) Appl. No.: 15/685,248

(22) Filed: Aug. 24, 2017

Related U.S. Application Data
(60) Provisional application No. 62/380,069, filed on Aug. 26, 2016.

(51) Int. Cl. B60P 3/34

(52) U.S. Cl. CPC B60P 3/34

(57) ABSTRACT

A recreational vehicle includes a ramp door that may be pivoted between a closed position and an open position. A rail system is pivotally mounted to the door. A mechanism transitions the rail system from a first position when the door is closed to a second position when the door is opened.

### CROSS-REFERENCE TO RELATED APPLICATION

This application claims benefit under 35 U.S.C. §119 of U.S. Provisional Patent Application No. 62/380,069, filed Aug. 26, 2016, and incorporates by reference the disclosure thereof in its entirety.

### BACKGROUND OF THE DISCLOSURE

A recreational vehicle (RV) may include a ramp door providing access between the interior of the RV and the environment about the RV. Such a ramp door typically is pivotally mounted to the RV proximate a floor thereof and pivotable about an axis parallel to and substantially flush with the floor. In a closed or stowed position, the ramp door may form a wall or a portion of a wall of the RV. For example, a ramp door may form a rear wall or a portion of a rear wall of an RV when closed.

The ramp door may be opened or deployed to a ramp position wherein the free end of the ramp door is adjacent the ground upon which the RV is parked. In this position, the ramp door may facilitate loading and unloading items to and from the interior of the RV.

In some embodiments, the ramp door may be partially opened or deployed to a position in which the ramp door is generally parallel to the floor of the RV. In this position, the ramp door may serve as a patio deck.

When the ramp door is used as a patio deck, a railing typically is installed about the perimeter of the ramp door except at the end of the door pivotally connected to the RV. Typically, at least portions of such railings must be removed from the ramp door prior to closing the door. When removed, such portions of the railing must be stored, for example, inside the RV. Conversely, when the ramp door is deployed to the patio deck configuration, the railing must be removed from its storage location and installed on the ramp door. These tasks may be time-consuming and may require two or more persons to accomplish.

### BRIEF DESCRIPTION OF THE DRAWINGS

FIG. 1 is a perspective view of a ramp door including a self-deploying rail with the ramp door in a patio deck configuration and the rail system fully deployed;

FIG. 2 is a detail perspective view of the ramp door and self-deploying rail of FIG. 1;

FIG. 3 is an end view of a first ramp door side edge member of the ramp door of FIG. 1;

FIG. 4 is a detail perspective view of the ramp door and self-deploying rail of FIG. 1;

FIG. 5 is a side elevation view of the ramp door and self-deploying rail of FIG. 1 with the door and rail fully deployed;

FIG. 6 is a side elevation view of the ramp door and self-deploying rail of FIG. 1 with the door and rail about 90% deployed;

FIG. 7 is a side elevation view of the ramp door and self-deploying rail of FIG. 1 with the door and rail about 60% deployed; and

FIG. 8 is a side elevation view of the ramp door and self-deploying rail of FIG. 1 with the door and rail about 30% deployed.

### DETAILED DESCRIPTION OF THE DRAWINGS

The drawings show illustrative embodiments of a system 10 including a ramp door 12 pivotable with respect to a structure, for example, an RV, a rail (or barrier) system pivotally attached to the ramp door, and an operating mechanism operable, in response to pivoting of the ramp door, to reposition portions of the rail system between a first (or collapsed) position in which the portions of the rail system are generally collapsed against the ramp door and a second (or deployed) position in which the portions of the rail system are generally perpendicular to the ramp door.

The ramp door 12 is shown as a panel P having a connected end pivotally attached to a door frame or hoop 14, a free end opposite the connected end and first and second opposed sides extending between the first end and second end of the door. The hoop 14 is configured for attachment to a structure, for example, an RV. The pivotal connection of the ramp door 12 to the hoop 14 may be made using one or more hinges (not shown) connected between the ramp door and the hoop proximate the bottom of the hoop. In other embodiments, the ramp door 12 could be pivotally attached to the RV or other structure in other ways. For example, the ramp door 12 could be pivotally attached to the floor or frame of the RV proximate the hoop.

As shown, the rail system includes an end rail portion 16 and first and second side rail portions 18, 18′. The end rail portion 16 includes a bottom rail 20, a first corner post 22 having a first or lower end connected to the bottom rail proximate a first end thereof, a second corner post 24 having a first or lower end connected to the bottom rail proximate a second end thereof, a pair of intermediate posts 26 having first or lower ends connected to the bottom rail between the first and second ends thereof, a top rail 28 connected to second or upper ends of the posts 22, 24, 26, and a plurality of intermediate rails 30, each having first and second ends connected to the first and second corner posts, respectively. Other embodiments could include more or fewer intermediate posts 26 (as few as none). In embodiments including intermediate posts 26, the intermediate rails may pass through apertures defined by the intermediate posts or otherwise be attached to the intermediate posts. As shown, the bottom rail 20, posts 20, 22, 24, 26, and top rail 28 are rigid elements, for example, tube steel or aluminum, and the intermediate rails 30 are flexible elements, for example, cables. In other embodiments, the intermediate rails 30 could be embodied as rigid elements, for example, rods or tubes, or otherwise. A cam 32 is attached to the first end of the bottom rail 20. Another cam 32′ is attached to the second end of the bottom rail 20. Each cam 32, 32′ has a corresponding lobe 34, 34′ defining a corresponding aperture configured to receive a corresponding pivot pin 35, 35′.

The end rail portion 16 extends from about the first side of the door 12 to about the second side of the door. The end rail portion 16 is pivotally connected to the door 12 proximate the free end thereof. As shown, the bottom rail 20 is pivotally attached to hinge brackets 36 using a suitable hinge mechanism. The hinge brackets 36 are attached to the door 12. The illustrated embodiment includes three hinge brackets 36. A first of the hinge brackets 36 is located near the first corner post 22, a second of the hinge brackets is located near the second corner post 24, and a third of the hinge brackets is located about midway between the first and second hinge brackets. Other embodiments could include more or fewer hinge brackets 36. Each hinge bracket 36 is shown as including a back flange 38 that limits the rotation of the bottom rail 20 with respect to the hinge bracket and that may provide angular support to the bottom rail when the end rail portion 16 is deployed. In other embodiments, the end rail portion 16 could be pivotally connected to the door 12 in other ways.

The first and second side rail portions 18, 18′ may be identical to or mirror images of each other. As such, only the first side rail portion 18 will be discussed in detail herein. Features of the first side rail portion 18 generally are identified herein with unprimed reference signs (for example, 18), and like features of the second side rail portion 18′ generally are identified herein with primed reference signs (for example, 18′).

The first side rail portion 18 includes a side post 42 pivotally connected to the door 12 proximate the first side of the door and intermediate the first corner post 22 of the end rail portion 16 and a corresponding jamb of the hoop 14. More specifically, the side post 42 is pivotally attached to a corresponding side post bracket 44. The side post bracket 44 is shown as having first and second side walls 43 and a rear wall 45. The side post 42 is pivotally attached to the side walls 43. The rear wall 45 may serve as a backstop limiting the pivoting of the side post 42 with respect to the side post bracket 44. The side post bracket 44 is attached to a corresponding block 46. The block 46 is configured to be slidingly received by a first channel of a side edge member of the door 12 and fixed thereto, as will be discussed further below. In an embodiment, the side post bracket 44 may be attached to the door in another manner, and the block 46 may be omitted.

The first side rail portion 18 also includes a plurality of flexible rails 48, each flexible rail having a first end connected to the first corner post 22 of the end rail portion 16 and a second end connected to the respective jamb of the hoop 14. Alternatively, the second end of each flexible rail 48 could be connected to an intermediary structure, for example, a plate or strip that is in turn attached to the jamb. As shown, the flexible rails 48 are embodied as cables. The flexible rails 48 may pass through corresponding apertures in the side post 42 or otherwise be attached to the side post.

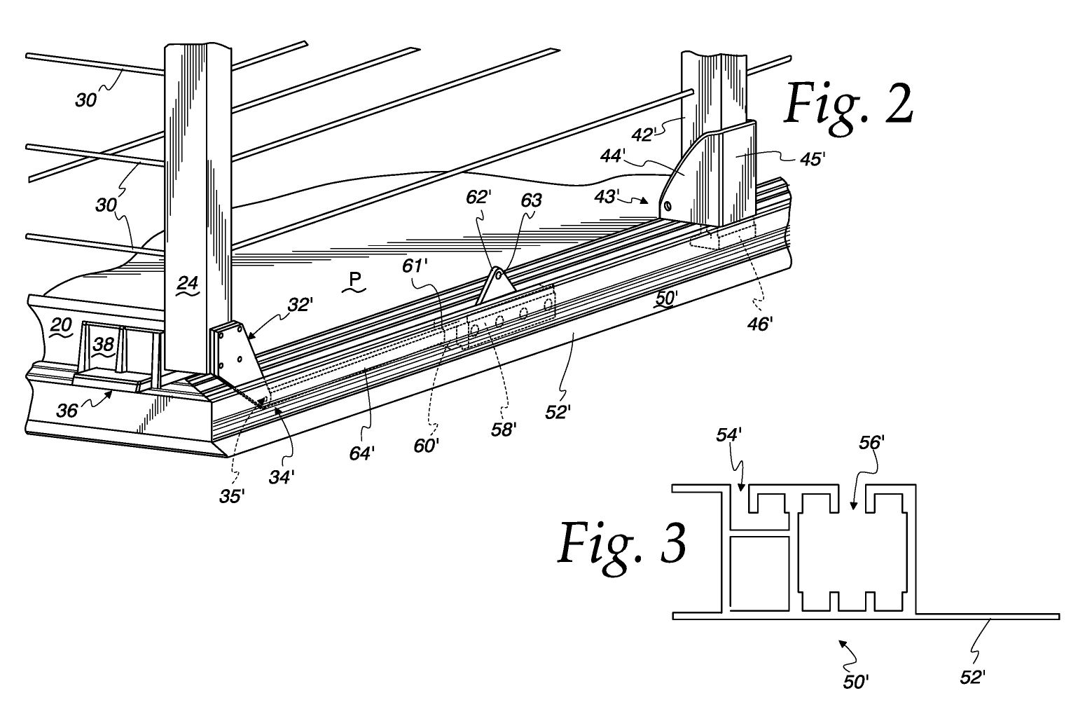

As suggested above, a first side edge member 50 extends along at least a portion of the first side edge of the door 12, and a second side edge member 50′ extends along at least a portion of the second side edge of the door. As best shown in FIGS. 2 and 3, each of the first and second side edge members 50, 50′ includes a flange 52, 52′ configured for attachment to the door 12. Also, each of the first and second side edge members 50, 50′ defines a first channel 54, 54′ configured to receive the block 46, 46′ attached to the side post bracket 44, 44′, and a second channel 56, 56′ configured to receive a slider 58, 58′, as suggested above. The first channel 54, 54′ slidingly receives the block 46, 46′. With the block 46, 46′ received at a desired location of the first channel 54, 54′, the block may be fixed to the side edge member 50, 50′. The second channel 56, 56′ receives the slider 58, 58′ in sliding engagement therewith. The second channel 56, 56′ also receives a slider travel stop 59, 59′ in sliding engagement therewith, which travel stop is then secured to the side edge member to limit the sliding travel of the slider 58, 58′ in the second channel 56, 56′.

The slider 58, 58′ includes a first tab 60, 60′ defining an aperture configured to receive a pivot pin 61, 61′. The slider 58, 58′ also includes a second tab 62, 62′ defining an aperture 63, 63′ configured to receive a cable or connector, as will be discussed further below. The slider 58, 58′ could be made of a low-friction material and/or incorporate rollers or bearings or the like to facilitate its ability to slide with respect to the side edge member 50, 50′. As suggested above, the slider travel stop 59, 59′ limits the sliding travel of the slider 58, 58′ in the second channel 56, 56′.

The slider 58, 58′ is connected to the lobe 34, 34′ of the cam 32, 32′ by a connector 64, 64′ having a first end pivotally connected to the cam and a second end pivotally connected to the first tab 60, 60′ of the slider by respective pivot pins. The connector 64, 64′ could be embodied as a rod, tube, cable chain, or other structure. At least a portion of the lobe 34, 34′ of the cam 32, 32′ is receivable within the second channel 56, 56′.

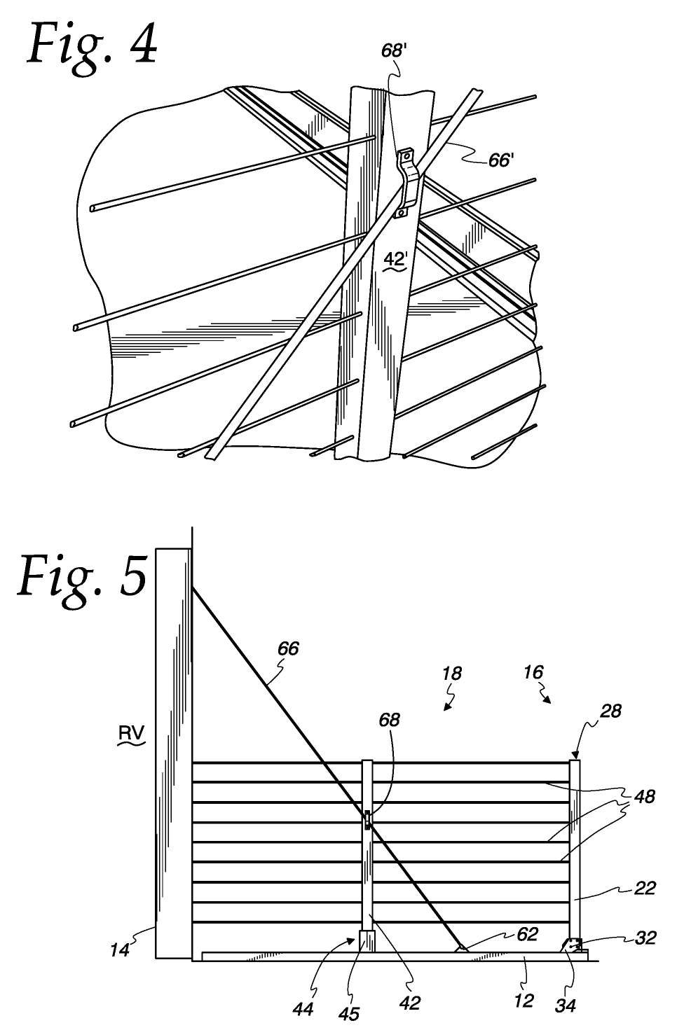

A cable 66, 66′ has a first end connected to the second tab 62, 62′ of the slider 58, 58′, either directly or through an intervening connector (not shown), and a second end connected or connectable to the hoop 14 or otherwise to the RV. As best shown in FIG. 4, an intermediate portion of the cable 66, 66′ is slidingly engaged with the side post 42, 42′. For example, the cable 66, 66′ may be slidingly captured between the side post 42, 42′ and a clip 68, 68′ attached to the side post.

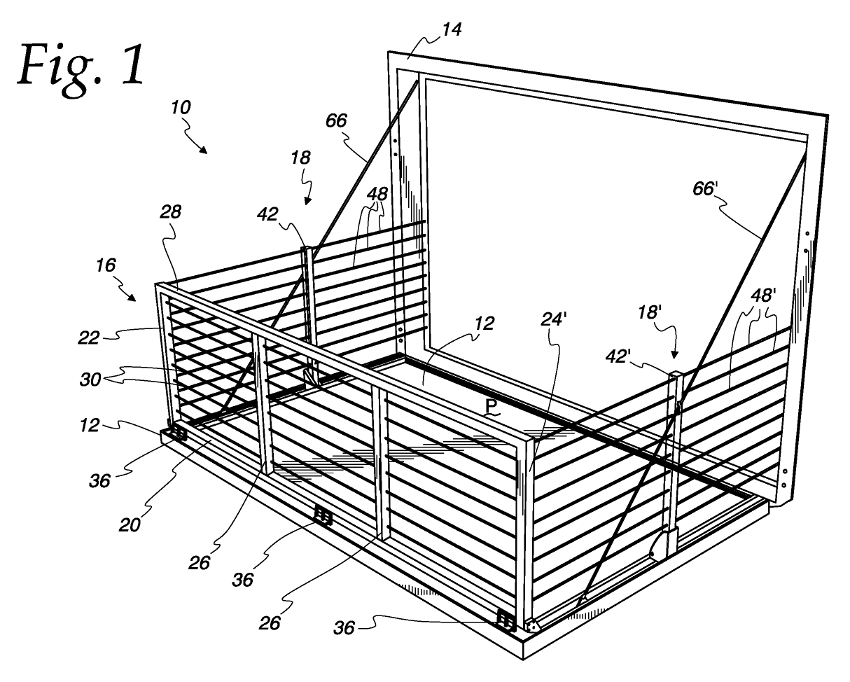

FIGS. 1, 2, 4, and 5 show the system 10 with the ramp door 12 and the end and side rail portions 16, 18, 18′ fully deployed. In this state, the slider 58, 58′ is displaced away from the free end of the door 12, toward the pivotally connected end of the door, and in abutment with the slider travel stop 59, 59′. Also, the cable 66, 66′ is taut between its attachment point at the hoop 14 and the slider. With the slider 58, 58′ so positioned, the connector 64, 64′ acts on the cam 32, 32′ to place the end rail portion 16 in a position generally perpendicular to the door panel P. Also in this state, the cable 66, 66′ substantially supports the ramp door 12 in the open position.

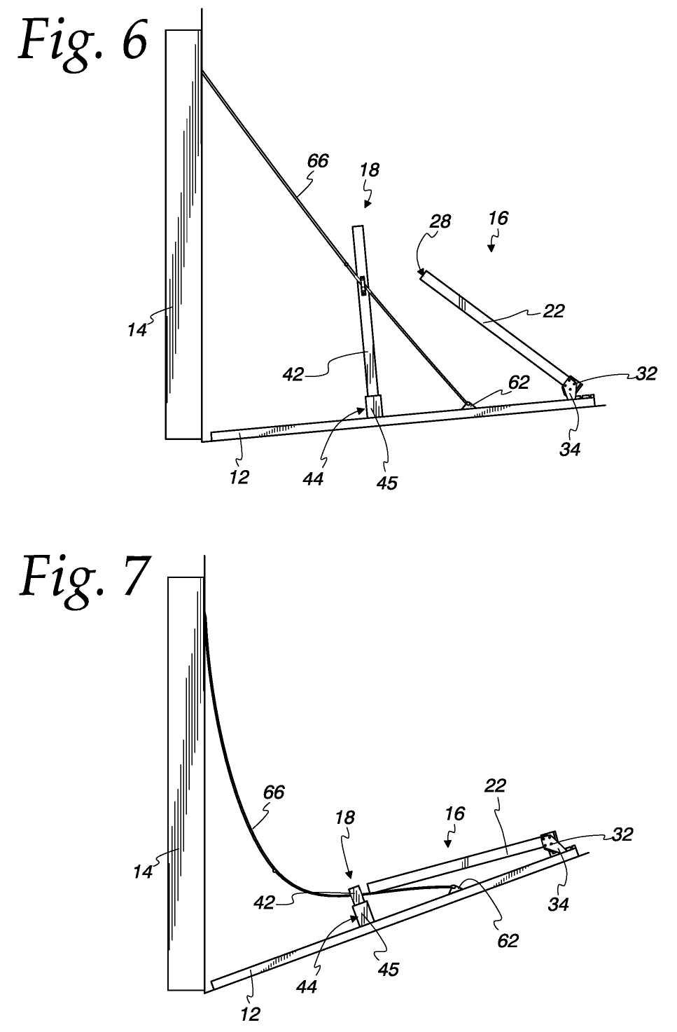

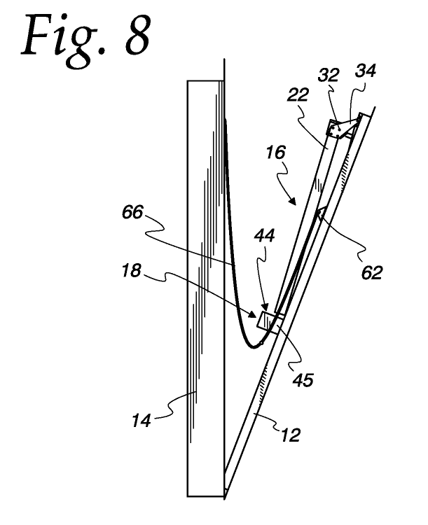

FIGS. 6-8 show the ramp door 12 and the end and side rail portions 16, 18, 18′ in progressively lesser stages of deployment as the door moves further from the open position toward the closed position. As the door 12 is pivoted toward the hoop 14, the cable 66, 66′ begins to slacken, allowing the slider 58, 58′ to slide toward the free end of the door 12. Once the door 12 has pivoted to a degree at which the weight of the first end portion 16 of the rail has a component parallel to the door panel P in the direction of the hoop 14, the end rail portion 16 may begin to pivot toward the door panel P under its own weight. As the end portion 16 rotates, the cam 32, 32′ rotates, thereby drawing the connector 64, 64′ and the slider 58, 58′ toward the free end of the door.

Continued rotation of the door 12 yields continued slackening of the cable 66, 66′, which leads to continued rotation of the end portion 16. Eventually, the end portion 16 may fold against the panel P. Also, as the cable 66, 66′ slackens and continues to slacken, the side post 42, 42 may similarly rotate toward and against the door panel P (into the page as shown in FIGS. 5-8). The flexible nature of the flexible rails 48 (omitted from FIGS. 6-8 for clarity) allows them to collapse against the panel P.

When the door and rail system 10 is deployed from a stowed configuration, the door 12 is pivoted away from the hoop 14, eventually causing the cable 66, 66′ to become taut. Continued rotation of the door 10 causes the taut cable 66, 66′ to displace the slider 58, 58′ within the channel 56, 56′ toward the pivotally connected end of the door. Such displacement of the slider 58, 58′ displaces the connecter 64, 64′, which in turn displaces the cam 32, 32′ connected to the end rail portion 16. When the door 10 is fully deployed, the slider 58, 58′ will have, via the connector 64, 64′, caused the cam 32, 32′ to rotate the end rail portion 16 to the deployed position, generally perpendicular to the door panel P.

One or more biasing mechanisms (not shown), for example, torsion springs associated with the hinges pivotally connecting the end rail portion 16 to the door 12, could be provided to initiate rotation of the end rail portion 16 from the deployed position to the stowed position. Similarly, one or more biasing mechanisms (not shown) could be provided to initiate rotation of the side post 42, 42′ from the deployed position to the stowed position. Also, one or more dampening mechanisms (not shown), for example, rubber bumpers between the end rail portion 16 and the door 12 and/or the side posts 42, 42′ and the door, to dampen the motion of the end rail portion and/or the side post during the transition from the deployed position to the stowed position.

One or more locking mechanisms and corresponding release mechanisms (not shown) may be provided to lock the end rail portion 16 and/or the side post 42, 42′ in the deployed and/or stowed positions and release them from the deployed and/or stowed positions.

The embodiments shown and described herein are illustrative and not limiting. For example, the rail system and operating mechanism may be embodied in other ways. The Features described in connection with any embodiment may be used in connection with any other embodiment to the greatest extent possible.

1. A system comprising:
a door frame;
a door having a first side, a second side, a pivot end and a free end, the door configured to pivot about the pivot end thereof with respect to the door frame between a first position in which the door is received within the door frame and a second position in which the door extends from the door frame; and
a rail system comprising:
an end rail portion pivotally connected proximate a pivot end of the end rail portion to the door proximate the free end of the door, the end rail pivotable between a first position in which the end rail portion is collapsed against the door and a second position in which the end rail portion is perpendicular to the door; and
an operating mechanism connected to the end rail portion, the operating mechanism operable to pivot the end rail portion between its first position and its second position in response to the pivoting of the door between its first position and its second position.

2. The system of claim 1,
the door comprising a first side rail extending along the first side of the door;
the end rail portion comprising a first cam proximate the pivot end thereof, the cam comprising a first cam lobe; and
the operating mechanism comprising:
a first slider slidingly engaged with the first side rail;
a first cable connected between the first slider and the door frame: and
a first connector connected to the first slider and pivotally connected to the first cam lobe.

3. The system of claim 2, the first side rail comprising a first slider channel, the first slider captured to and slidingly engaged with the first slider channel.

4. The system of claim 3, the rail system further comprising:
a first side post pivotally connected to the door proximate the first side thereof intermediate the free end and the pivot end of the door, the first side post pivotable between a first position in which the first side post is collapsed against the door and a second position in which the first side post is perpendicular to the door; and
a second side post pivotally connected to the door proximate the second side thereof intermediate the free end of and the pivot end of the door, the second side post pivotable between a first position in which the second side post is collapsed against the door and a second position in which the second side post is perpendicular to the door;
the operating mechanism further connected to the first side post and the second side post and further operable to pivot the first side post and the second side post between their respective first positions and second positions in response to the pivoting of the door between its first position and second position.

5. The system of claim 4 further comprising a biasing mechanism configured to bias the first side post toward its first position.

6. The system of claim 4, the first cable operably engaged with the first side post.

7. The system of claim 4, the first cable slidingly engaged with the first side post.

8. The system of claim 4, the end rail portion pivotally connected to the door by a hinge bracket, the hinge bracket having a backstop configured to limit rotation of the end rail portion from the respective first position beyond the respective second position.

9. The system of claim 8, the first side post pivotally connected to the door by a first side post bracket, the first side post bracket having a backstop configured to limit rotation of the first side post from the respective first position beyond the respective second position.

10. The system of claim 6, the first side rail further comprising a first side post channel, the first side post captured to and slidingly engaged with the first side post channel.

11. The system of claim 1, the rail system further comprising:
a first side post pivotally connected to the door proximate the first side thereof intermediate the free end and the pivot end of the door, the first side post pivotable between a first position in which the first side post is collapsed against the door and a second position in which the first side post is perpendicular to the door; and
a second side post pivotally connected to the door proximate the second side thereof intermediate the free end and the pivot end of the door, the second side post pivotable between a first position in which the second side post is collapsed against the door and a second position in which the second side post is perpendicular to the door;
the operating mechanism further connected to the first side post and the second side post and further operable to pivot the first side post and the second side post between their respective first positions and second positions in response to the pivoting of the door between its first position and second position.

12. The system of claim 11, the first cable operably engaged with the first side post.

13. The system of claim 11, the first cable slidingly engaged with the first side post.

14. The system of claim 1, the end rail portion pivotally connected to the door by a hinge bracket, the hinge bracket having a backstop configured to limit rotation of the end rail portion from the respective first position beyond the respective second position.

15. The system of claim 1 further comprising a first flexible rail member engaged with the first side post, the first flexible rail member connected at a first end thereof to the end rail portion and at a second end thereof to the door frame.

16. The system of claim 1 further comprising a biasing mechanism configured to bias the end rail portion toward its first position.
